(19) United States
(12) Patent Application Publication
(10) Pub. No.: US 2024/0402897 A1
(43) Pub. Date: Dec. 5, 2024

(54) METHOD, APPARATUS, ELECTRONIC DEVICE AND STORAGE MEDIUM FOR DISPLAYING INFORMATION

(71) Applicant: Beijing Zitiao Network Technology Co., Ltd., Beijing (CN)

(72) Inventors: Qingyu LAI, Beijing (CN); Yiping ZHENG, Beijing (CN); Chaoyi ZHANG, Beijing (CN)

(21) Appl. No.: 18/699,222

(22) PCT Filed: Sep. 30, 2022
(86) PCT No.: PCT/CN2022/123395

§ 371 Date: Apr. 5, 2024

(30) Foreign Application Priority Data
Oct. 8, 2021 (CN) 202111172662.3

(51) Int. Cl. G06F 3/04847; G06F 3/04812

(52) U.S. Cl. CPC G06F 3/04847; G06F 3/04812

(57) ABSTRACT

A method, apparatus, electronic device, and storage medium for displaying information. The method for displaying information includes: receiving a first operation on a content block in a document; in response to the first operation, displaying a first function identifier in an associated area of the content block, the first function identifier comprising a first sub-identifier and a second sub-identifier, the first sub-identifier used to represent a content type of the content block, and the second sub-identifier used to represent an operation type of the content block.

### CROSS REFERENCE

The present application claims priority to Chinese Patent Application No. 202111172662.3, filed on Oct. 8, 2021, and entitled “Method, apparatus, electronic device and storage medium for displaying information”, the entirety of which is incorporated herein by reference.

### FIELD

The present disclosure relates to the field of computer technology, and specifically relates to a method, apparatus, electronic device, and storage medium for displaying information.

### BACKGROUND

A toolbar button is an entry point of general and characteristic functions of the selected content block. Currently, the style of the toolbar button used for loading a content block in electronic documents is single and lacks visual expression of the type of the content block.

### SUMMARY

The summary is provided to briefly introduce concepts, which will be described in detail in the following detailed description sections. This summary is not intended to identify key features or necessary features of the claimed technical solution, nor is it intended to limit the scope of the claimed technical solution.

In a first aspect, according to one or more embodiments of the present disclosure, there is provided a method of displaying information, comprising:
receiving a first operation on a content block in a document; and
in response to the first operation, displaying a first function identifier in an associated area of the content block, the first function identifier comprising a first sub-identifier and a second sub-identifier, the first sub-identifier used to represent a content type of the content block, and the second sub-identifier used to represent an operation type of the content block.

In a second aspect, according to one or more embodiments of the present disclosure, there is provided an apparatus for displaying information, comprising:
an operation receiving unit configured for receiving a first operation on a content block in a document; and
an identifier displaying unit configured for, in response to the first operation, displaying a first function identifier in an associated area of the content block, the first function identifier comprising a first sub-identifier and a second sub-identifier, the first sub-identifier used to represent a content type of the content block, and the second sub-identifier used to represent an operation type of the content block.

In a third aspect, according to one or more embodiments of the present disclosure, there is provided an electronic device, comprising: at least one memory and at least one processor; wherein the memory is used to store program code, and the processor is used to call the program code stored in the memory to cause the electronic device to perform a method of displaying information provided by one or more embodiments of the present disclosure.

In a fourth aspect, according to one or more embodiments of the present disclosure, there is provided a non-transitory computer storage medium, the non-transitory computer storage medium stores program code that, when executed by a computer device, causes the computer device to perform a method of displaying information provided by one or more embodiments of the present disclosure.

According to one or more embodiments of the present disclosure, in response to a first operation by a user on a content block, a first function identifier is displayed, and the first function identifier comprises a first sub-identifier used to represent a content type of the content block and a second sub-identifier used to represent an operation type of the content block, thereby facilitating the user to know the content type and operation type of the current content block, and increasing the discrimination of each content block.

### BRIEF DESCRIPTION OF THE DRAWINGS

In conjunction with the accompanying drawings and with reference to the following detailed description, the above and other features, advantages and aspects of the various embodiments of the present disclosure will become more apparent. Throughout the drawings, like or similar reference numerals denote like or similar elements. It should be understood that the drawings are illustrative and that the original and elements are not necessarily drawn to scale.

FIG. 1 is a flowchart of a method of displaying information according to an embodiment of the present disclosure;

FIG. 2 is a flowchart of a method of displaying information according to another embodiment of the present disclosure;

FIGS. 3A and 3B are schematic diagrams of a first function identifier according to an embodiment of the present disclosure;

FIG. 4 is a schematic diagram of a first function identifier according to another embodiment of the present disclosure;

FIG. 5 is a schematic structural diagram of an apparatus for displaying information according to an embodiment of the present disclosure; and

FIG. 6 is a schematic structural diagram of an electronic device according to an embodiment of the present disclosure.

### DETAILED DESCRIPTION

The embodiments of the disclosure will be described in more detail below with reference to the accompanying drawings. Although some embodiments of the disclosure are shown in the accompanying drawings, it should be understood that the disclosure may be implemented in various forms and should not be construed as being limited to the embodiments described herein, on the contrary, these embodiments are provided for a more thorough and complete understanding of the disclosure. It should be understood that the accompanying drawings and embodiments of the disclosure are merely illustrative, rather than limiting the scope of protection of the disclosure.

It should be understood that the steps described in the embodiments of the disclosure may be performed according to different orders and/or in parallel. In addition, the embodiments may include additional steps and/or omit the execution of the shown steps. The scope of the disclosure is not limited in this aspect.

The term “comprising” used herein and variants thereof means open-ended including, i.e., “comprising, but not limited to”. The term “based on” refers to “based at least in part on”. The term “one embodiment” represents “at least one embodiment”; the term “the other embodiment” represents “at least one additional embodiment”; and the term “some embodiments” represents “at least some embodiments”. The term “in response to” and related terms mean that one signal or event is influenced to some extent by another signal or event, but not necessarily completely or directly. If an event x occurs “in response to” event y, x can be directly or indirectly in response to y. For example, the occurrence of y can eventually result in the occurrence of x, but there may be other intermediate events and/or conditions. In other scenarios, y may not necessarily result in the occurrence of x, and x may occur even though y has not occurred. In addition, the term “in response to” can also mean “at least partially in response to”.

The term “determining” comprises a wide variety of actions, including acquiring, calculating, computing, processing, deriving, investigating, looking up (e.g., looking up in a database, a table, or another data structure), ascertaining and the like, and may include receiving (e.g., receiving information), accessing (e.g., accessing data in a memory) and the like, as well as parsing, selecting, choosing, establishing and the like. Definitions of other terms will be provided in the description below.

It should be noted that the terms such as “first”, “second” and the like mentioned in the disclosure are merely intended to distinguish different apparatuses, modules, or units, rather than limiting an order of functions executed by these apparatuses, modules or units or an interdependence among these apparatuses, modules, or units.

It should be noted that the modifications of “a” and “a plurality of” mentioned in the disclosure are illustrative, but are not restrictive. It should be understood by those skilled in the art that it should be understood as “one or more” unless otherwise specified in the context.

For the purposes of the disclosure, the phrase “A and/or B” means (A), (B), or (A and B).

Names of messages or information interacted among a plurality of apparatuses in the embodiments of the disclosure are merely for an illustrative purpose, rather than limiting the scope of these messages or information.

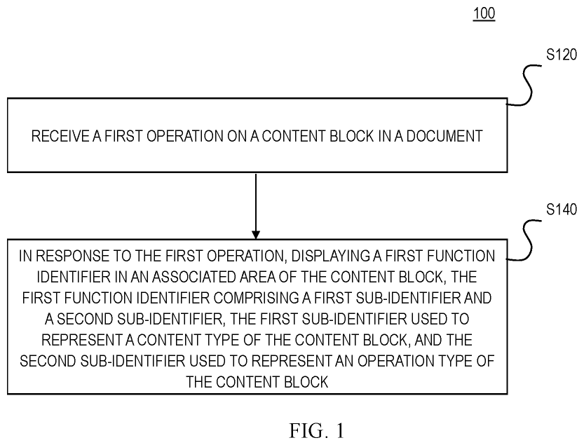

Referring to FIG. 1, FIG. 1 shows a flowchart of a method 100 of displaying information provided by an embodiment of the present disclosure, and the method 100 comprises:
step S120: receive a first operation on a content block in a document;
the first operation includes but is not limited to touch operation, floating touch, click operation, gesture operations and the like on a content block.

The content block is a basic unit of a document page. A document page can be composed of a plurality of content blocks, and text, images, files and the like can be displayed in the content block. The files can include a text format or other formats, such as multimedia files, etc.

Step S140: in response to the first operation, display a first function identifier in an associated area of the content block, the first function identifier comprises a first sub-identifier and a second sub-identifier, the first sub-identifier is used to represent a content type of the content block, and the second sub-identifier is used to represent an operation type of the content block.

It should be noted that the associated area can be located within the display area of the content block or outside the display area of the content block, for example, close to the display area of the content block, which is not limited in this disclosure.

In some embodiments, the content type of the content block includes, but not limited to, a text type, an image type, a chart type, a file type, etc. Content blocks of different content types may be associated with different styles of the first sub-identifiers. As an example, the first sub-identifier may be an icon of a toolbar button of the content block, which can display a pattern reflecting the content type of the content block. When a user clicks on the icon of the toolbar button, a toolbar menu corresponding to the content block can be displayed so that the user can operate the content block through the function menu.

In some embodiments, the type of operation represented by the second sub-identifier is used to represent the predetermined functions configured by the content block, including but not limited to moving the content block, copying the content block, deleting the content block, downloading the document contained in the content block, etc. As an example, the second sub-identifier may be a drag icon of the content block, and the user can move the position of the content block by dragging the drag icon.

In this way, according to the method for displaying information provided by the present disclosure, the first function identifier is displayed in response to a first operation by a user on the content block, and the first function identifier includes a first sub-identifier for representing the content type of the content block and a second sub-identifier for representing the operation type of the content block, so that the user can easily know the content type and operation type of the current content block, thereby increasing the discrimination of each content block.

In some embodiments, the first operation includes hovering the cursor within a predetermined area corresponding to the content block. The predetermined area may completely overlap or partially overlap with the display area of the content block, which is not limited in the present disclosure. Therefore, when the user hovers the mouse over the predetermined area corresponding to the content block, the first function identifier corresponding to the content block can be displayed, which improves the efficiency of interaction.

In some embodiments, the method 100 further includes:
step S151: in response to a second operation by a user on the first sub-identifier, display a function list of the content block; and/or,
step S152: in response a third operation by a user on the second sub-identifier, move the content block.

The second operation includes but not is limited to touch, floating touch, click, gesture operations and the like on the first sub-identifier; the third operation includes but is not limited to a drag operation on the second sub-identifier.

In this way, according to one or more embodiments of the present disclosure, the first function identifier can be used as a drag icon to be dragged by the user to move the content block, and can also be a function list for displaying the content block.

In some embodiments, method 100 further includes:
step S160: if a type of the content block to which the first operation points is not determined, displaying a second function identifier. As an example, the second function identifier can be a predetermined default icon.

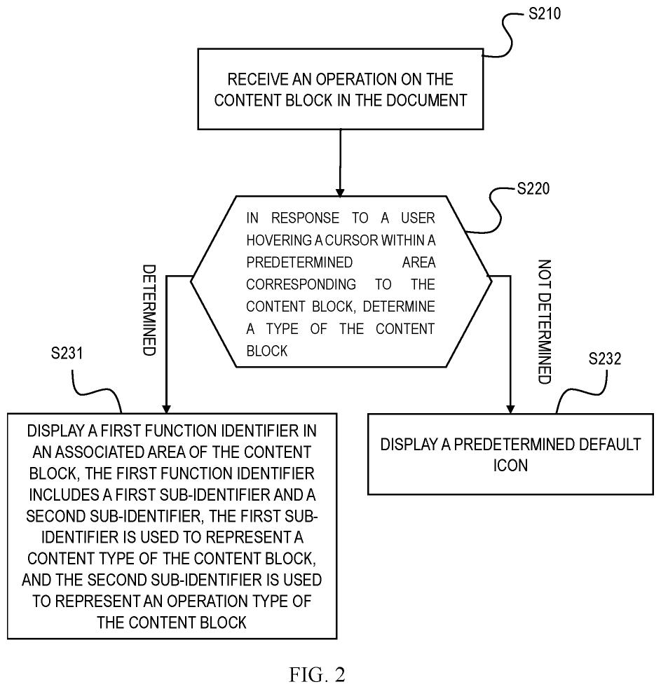

FIG. 2 shows a flowchart of a method 200 of displaying information provided by an embodiment of the present disclosure, the method 200 includes:
step S210: receive an operation on the content block in the document;
step S220: in response to a user hovering a cursor within a predetermined area corresponding to the content block, determine a type of the content block;
step S231: in response to the type of the content block is determined, display a first function identifier in an associated area of the content block, the first function identifier includes a first sub-identifier and a second sub-identifier, the first sub-identifier is used to represent a content type of the content block, and the second sub-identifier is used to represent an operation type of the content block;
step S232: in response to the type of the content block is not determined, display a predetermined default icon.

In some embodiments, method 100 further includes:
step S170: in response to a fourth operation by a user on a blank text line of the document, display a third function identifier, wherein the third function identifier is used to create the content block.

As an example, the blank text line of the document includes a text line to which no content blocks have been added; a fourth operation by a user on the blank text line of the document may be to hover a cursor over the blank text line.

In the present embodiment, the user can create a content block by performing a fourth operation on the blank text line.

In some embodiments, method 100 further includes:
step S180: in response to the third function identifier being selected, display a control panel for displaying at least one content block identifier; wherein the third function identifier is used to create the content block and the content block identifier and the first sub-identifier of a same content block have a correspondence.

As an example, the control panel can display the content block identifier of content blocks of image type, video type, file type, icon type, etc. When the user selects a content block identifier of one of the types, the content block of the corresponding type is created in the blank text line.

In some embodiments, if the content type of the content block is a non-text type, the first sub-identifier is identical to a content block identifier of the content block; and/or, if the content type of the content block is a text type, the first sub-identifier of the content block is a text identifier.

As an example, for content blocks of image type, the content block identifier displayed in the control panel can be exactly the same as its first sub-identifier, for example, both are the identifier “Img”; for content blocks of text type, the content block identifier displayed in the control panel can be specifically text and graphic identifiers such as “team” and “user”. For example, the content block whose content block identifier is “team” can be used to display a certain team name or group name, and the content block whose content block identifier is “user” can be used to display a certain user name. Regardless of the content block identified by “team” or a content block identified by “user”, its first sub-identifier can be a text identifier “T”. In this way, for content blocks of text type, its first sub-identifier can correspond to a plurality of different content block identifiers, thereby simplifying the type of the first sub-identifier and facilitating users to identify the type of content block through the first sub-identifier.

In some embodiments, if the content block is a text type comprising a title, the method 100 further comprises:
step A1: determine the first sub-identifier based on a title level of the title.

In some embodiments, if the content block is a text type, the method 100 further comprises:
step B1: in response to receiving an operation setting a title of the content block, set the content block to a title format;
step B2: determine a title level of the title, and determining the first sub-identifier based on the title level of the title.

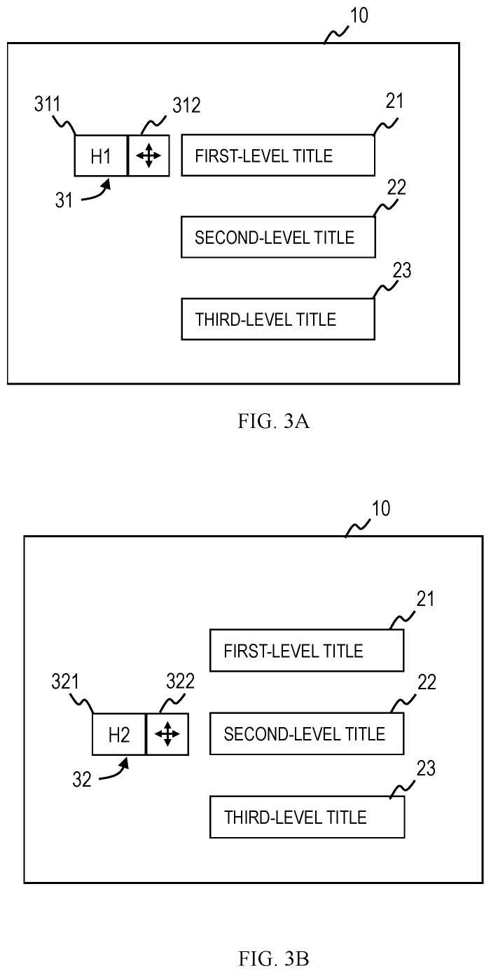

Referring to FIGS. 3A and 3B, the document 10 includes content blocks 21, 22, and 23 of the text type, which display different levels of titles with different sub-types respectively. The content block 21 displays the first-level title, the content block 22 displays the second-level title, and the content block 23 displays the third-level title. Referring specifically to FIG. 3A, when the user hovers a cursor (not shown in the FIG) over the content block 21 with a title level of “first-level title”, the first function identifier 31 is displayed. The first function identifier 31 includes the first sub-identifier 311 and the second sub-identifier 312. The first sub-identifier 311 displays an icon “H1” to indicate that the type of the content block 21 is “first-level title”. Referring specifically to FIG. 3B, when the user hovers a cursor (not shown in the FIG) over the content block 22 with a type of “second-level title”, the first function identifier 32 is displayed. The first function identifier 32 includes the first sub-identifier 321 and the second sub-identifier 322. The first sub-identifier 321 displays an icon “H” to indicate that the type of the content block 21 is “second-level title”.

Therefore, according to one or more embodiments of the present disclosure, the first sub-identifier is determined according to the title level corresponding to the content block of the text type, which can be convenient for the user to quickly distinguish the title level corresponding to the current content block.

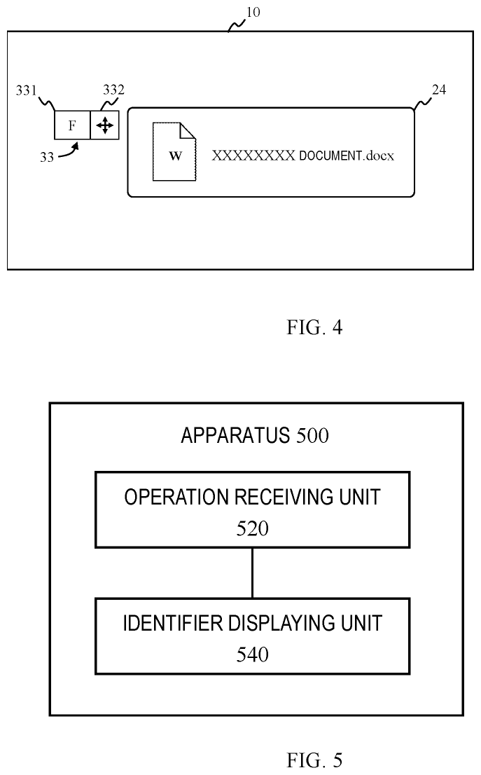

Referring to FIG. 4, the document 10 includes the content block 24 of a document type, within which a file in the format of “docx” is inserted. When the user hovers a cursor (not shown in the FIG) over the content block 24, a first function identifier 33 is displayed. The first function identifier 33 includes a first sub-identifier 331 and a second sub-identifier 332. The first sub-identifier 311 displays an icon “F” to indicate that the type of the content block 24 is “file”.

Correspondingly, as shown in FIG. 5, according to an embodiment of the present disclosure, an apparatus for displaying information 500 is provided, comprising:
an operation receiving unit 520 configured for receiving a first operation on a content block in a document;
an identifier displaying unit 540 configured for, in response to the first operation, displaying a first function identifier in an associated area of the content block, the first function identifier comprising a first sub-identifier and a second sub-identifier, the first sub-identifier used to represent a content type of the content block, and the second sub-identifier used to represent an operation type of the content block.

According to the apparatus for displaying information provided by one or more embodiments of the present disclosure, in response to a first operation by a user on a content block, a first function identifier is displayed, and the first function identifier comprises a first sub-identifier used to represent a content type of the content block and a second sub-identifier used to represent an operation type of the content block, thereby facilitating the user to know the content type and operation type of the current content block, and increasing the discrimination of each content block.

In some embodiments, the apparatus 500 further comprises:
a second identifier displaying unit configured for, if a type of the content block to which the first operation points is not determined, displaying a second function identifier.

In some embodiments, the apparatus 500 further comprises:
a third identifier displaying unit configured for, in response to a fourth operation by a user on a blank text line of the document, displaying a third function identifier, wherein the third function identifier is used to create the content block.

In some embodiments, the apparatus 500 further comprises:
a control panel displaying unit configured for, in response to the third function identifier being selected, displaying a control panel for displaying at least one content block identifier; wherein the content block identifier and the first sub-identifier of a same content block have a correspondence.

In some embodiments, the apparatus 500 further comprises:
a first determining unit configured for, if the content block is a text type comprising a title, determining the first sub-identifier based on a title level of the title.

In some embodiments, the apparatus 500 further comprises:
a first determining unit configured for, if the content block is a text type, in response to receiving an operation setting a title of the content block, setting the content block to a title format; and determining a title level of the title, and determining the first sub-identifier based on the title level of the title.

For the apparatus embodiments, since they basically corresponds to the method embodiments, the relevant part can refer to the part of the description of the method embodiments. The apparatus embodiments described above are merely illustrative, and the modules described as separate modules may or may not be separate. Some or all of the modules can be selected according to actual needs to achieve the objects of the solutions of the embodiments. Those of ordinary skill in the art can understand and implement without creative work.

Correspondingly, according to one or more embodiments of the present disclosure, there is provided an electronic device comprising:
at least one memory and at least one processor;
wherein the memory is used to store program code, and the processor is used to call the program code stored in the memory to cause the electronic device to perform a method of displaying information according to one or more embodiments of the present disclosure.

Correspondingly, according to one or more embodiments of the present disclosure, there is provided a non-transitory computer storage medium, the non-transitory computer storage medium stores program code, the program code can be executed by a computer device to cause the computer device to perform a method of displaying information according to one or more embodiments of the present disclosure.

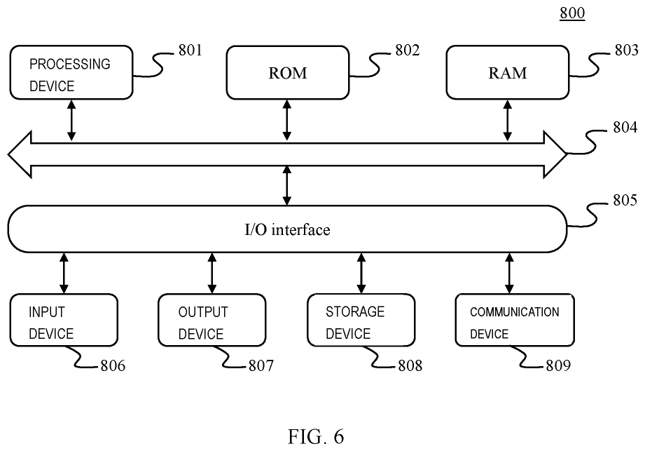

Now referring to FIG. 6, a structural schematic diagram of electronic device 800 suitable for implementing an embodiment of the disclosure is shown. The terminal equipment in the embodiment of the present disclosure can include, but is not limited to, mobile terminals such as a mobile phone, a notebook computer, a digital broadcast receiver, a PDA (personal digital assistant), a Pad (tablet computer), a PMP (portable media player) and a vehicle-mounted terminal (e.g., vehicle-mounted navigation terminal), and fixed terminals such as a digital TV and a desktop computer. The electronic device shown in FIG. 6 is only an example, and should not bring any restrictions on the functions and application scope of the embodiments of the present disclosure.

As shown in FIG. 6, the electronic device 800 may include a processing device (e.g., central processor, graphics processor, etc.) 801 that may perform various appropriate actions and processes based on programs stored in read-only memory (ROM) 802 or loaded into random access memory (RAM) 803 from the storage device 808. Also stored in RAM 803 are various programs and data required for the operation of electronic device 800. The processing device 801, ROM 802, and RAM 803 are connected to each other via bus 804. The input/output (I/O) interface 805 is also connected to the bus 804.

Typically, the following devices can be connected to I/O interface 805: input device 806 including, for example, touch screens, touch pads, keyboards, mice, cameras, microphones, accelerometers, gyroscopes, etc.; output device 807 including, for example, liquid crystal displays (LCDs), speakers, vibrators, etc.; storage device 808 including, for example, magnetic tapes, hard drives, etc.; and communication device 809. Although FIG. 6 shows the electronic device 800 with various devices, it should be understood that it is not required to implement or provide all the devices shown. More or fewer devices may alternatively be implemented or provided.

In particular, according to embodiments of the present disclosure, the process described above with reference to the flowchart may be implemented as a computer software program. For example, embodiments of the present disclosure include a computer program product comprising a computer program carried on a computer readable medium, the computer program comprising program code for performing the method shown in the flowchart. In such an embodiment, the computer program may be downloaded and installed from a network via a communication device 809, or from a storage device 808, or from a ROM 802. When this computer program is executed by the processing device 801, the above-described functions as defined in the method of this disclosed embodiment are performed.

It is to be noted that the computer-readable medium described above in this disclosure may be a computer-readable signal medium or a computer-readable storage medium or any combination of the above. The computer readable storage medium may be, for example—but not limited to—an electrical, magnetic, optical, electromagnetic, infrared, or semiconductor system, device, or device, or any combination of the above. More specific examples of computer-readable storage media may include, but are not limited to: electrically connected with one or more wires, portable computer disks, hard disks, random access memory (RAM), read-only memory (ROM), erasable programmable read-only memory (EPROM or flash memory), optical fiber, portable compact disk read-only memory (CD-ROM), optical storage devices, or any of the above, magnetic memory devices, or any suitable combination of the foregoing. In the present disclosure, a computer-readable storage medium may be any tangible medium that contains or stores a program that may be used by or in combination with an instruction execution system, device, or device. And in the present disclosure, a computer-readable signal medium may include a data signal propagated in the baseband or as part of a carrier wave that carries computer-readable program code. Such propagated data signals may take a variety of forms, including but not limited to electromagnetic signals, optical signals, or any suitable combination of the foregoing. Computer-readable signal medium can also be any computer-readable medium other than computer-readable storage media, the computer-readable signal medium can send, propagate or transmit the program for use by or in combination with the instruction execution system, device or device. The program code contained on the computer-readable medium may be transmitted using any suitable medium, including but not limited to: wire, fiber optic cable, RF (radio frequency), etc., or any suitable combination of the above.

In some implementations, the client, server may communicate using any currently known or future developed network protocol such as HTTP (HyperText Transfer Protocol), and may interconnect with any form or medium of digital data communication (e.g., a communication network). Examples of communication networks include local area networks (“LANs”), wide area networks (“WANs”), inter-networks (e.g., the Internet), and end-to-end networks (e.g., ad hoc end-to-end networks), as well as any currently known or future developed networks.

The above computer-readable medium may be contained in the above electronic device; or it may be present separately and not assembled into the electronic device.

The above computer readable medium carries one or more programs which, when executed by the electronic device, cause the electronic device to perform the methods of the present disclosure as described above.

Computer program code for performing the operations of the present disclosure may be written in one or more programming languages or combinations thereof, including object-oriented programming languages—such as Java, Smalltalk, C++, and also including conventional procedural programming languages—such as “C” language or similar programming languages. The program code may be executed entirely on the user's computer, partially on the user's computer, as a stand-alone package, partially on the user's computer and partially on a remote computer, or entirely on a remote computer or server. In the case of a remote computer, the remote computer may be connected to the user computer over any kind of network—including a local area network (LAN) or a wide area network (WAN)—or, alternatively, may be connected to an external computer (e.g., using an Internet service provider to connect over the Internet).

The flowcharts and block diagrams in the accompanying drawings illustrate the possible implementations of the architecture, functionality, and operation of systems, methods, and computer program products in accordance with various embodiments of the present disclosure. At this point, each box in a flowchart or block diagram may represent a module, program segment, or portion of code that contains one or more executable instructions for implementing a specified logical function. It should also be noted that in some implementations as replacements, the functions indicated in the boxes may also occur in a different order than that indicated in the accompanying drawings. For example, two boxes represented one after the other can actually be executed in substantially parallel, and they can sometimes be executed in the opposite order, depending on the function involved. Note also that each box in the block diagram and/or flowchart, and the combination of boxes in the block diagram and/or flowchart, may be implemented with a dedicated hardware-based system that performs the specified function or operation, or may be implemented with a combination of dedicated hardware and computer instructions.

The units described in the embodiments of the present disclosure may be implemented by means of software, or by means of hardware. Wherein, the name of the unit does not in some cases constitute a limitation on the unit itself.

The functions described above herein may be performed, at least in part, by one or more hardware logic components. For example, non-limitingly, example types of hardware logic components that may be used include: field-programmable gate arrays (FPGAs), application-specific integrated circuits (ASICs), application-specific standard products (ASSPs), systems-on-chip (SOCs), complex programmable logic devices (CPLDs), and the like.

In the context of the present disclosure, a machine-readable medium may be a tangible medium that may contain or store a program for use by or in conjunction with an instruction execution system, apparatus, or device. The machine-readable medium may be a machine-readable signal medium or a machine-readable storage medium. Machine readable media may include, but are not limited to, electronic, magnetic, optical, electromagnetic, infrared, or semiconductor systems, devices, or equipment, or any suitable combination of the foregoing. More specific examples of machine-readable storage media would include one or more wire-based electrical connections, portable computer disks, hard disks, random access memory (RAM), read-only memory (ROM), erasable programmable read-only memory (EPROM or flash memory), optical fiber, convenient compact disk read-only memory (CD-ROM), optical storage devices, magnetic storage devices, or any suitable combination of the above any suitable combination of the above.

According to one or more embodiments of the present disclosure, there is provided a method of displaying information, comprising: receiving a first operation on a content block in a document; and in response to the first operation, displaying a first function identifier in an associated area of the content block, the first function identifier comprising a first sub-identifier and a second sub-identifier, the first sub-identifier used to represent a content type of the content block, and the second sub-identifier used to represent an operation type of the content block.

The method of displaying information according to one or more embodiments of the present disclosure, further comprising: in response to a second operation by a user on the first sub-identifier, displaying a function list of the content block; and/or in response a third operation by a user on the second sub-identifier, moving the content block.

The method of displaying information according to one or more embodiments of the present disclosure, further comprising: if a type of the content block to which the first operation points is not determined, displaying a second function identifier.

The method of displaying information according to one or more embodiments of the present disclosure, further comprising: in response to a fourth operation by a user on a blank text line of the document, displaying a third function identifier, wherein the third function identifier is used to create the content block.

The method of displaying information according to one or more embodiments of the present disclosure, further comprising: in response to the third function identifier being selected, displaying a control panel for displaying at least one content block identifier; wherein the content block identifier and the first sub-identifier of a same content block have a correspondence.

The method of displaying information according to one or more embodiments of the present disclosure, wherein if the content type of the content block is a non-text type, the first sub-identifier is identical to a content block identifier of the content block; and/or, if the content type of the content block is a text type, the first sub-identifier of the content block is a text identifier.

The method of displaying information according to one or more embodiments of the present disclosure, wherein if the content block is a text type comprising a title, the method further comprises: determining the first sub-identifier based on a title level of the title.

The method of displaying information according to one or more embodiments of the present disclosure, wherein if the content block is a text type, the method further comprises: in response to receiving an operation setting a title of the content block, setting the content block to a title format; and determining a title level of the title, and determining the first sub-identifier based on the title level of the title.

The method of displaying information according to one or more embodiments of the present disclosure, wherein the first operation comprises a user hovering a cursor within a predetermined area corresponding to the content block.

According to one or more embodiments of the present disclosure, there is provided an apparatus for displaying information, comprising: an operation receiving unit configured for receiving a first operation on a content block in a document; and an identifier displaying unit configured for, in response to the first operation, displaying a first function identifier in an associated area of the content block, the first function identifier comprising a first sub-identifier and a second sub-identifier, the first sub-identifier used to represent a content type of the content block, and the second sub-identifier used to represent an operation type of the content block.

According to one or more embodiments of the present disclosure, there is provided an electronic device, comprising: at least one memory and at least one processor; wherein the memory is used to store program code, and the processor is used to call the program code stored in the memory to cause the electronic device to perform the method according to one or more embodiments of the present disclosure.

According to one or more embodiments of the present disclosure, there is provided a non-transitory computer storage medium, wherein the non-transitory computer storage medium stores program code that, when executed by a computer device, causes the computer device to perform the method according to one or more embodiments of the present disclosure.

The above description is only a better embodiment of the present disclosure and a description of the technical principles applied. It should be understood by those skilled in the art that the scope of the disclosure covered by the present disclosure is not limited to technical solutions formed by specific combinations of the above technical features, but should also cover other technical solutions formed by any combination of the above technical features or their equivalent features without departing from the above disclosed idea. For example, the above features are interchangeable with (but not limited to) technical features with similar functions disclosed in the present disclosure.

Further, while the operations are depicted in a particular order, this should not be construed as requiring that the operations be performed in the particular order shown or in sequential order. Multitasking and parallel processing may be advantageous in certain environments. Again, while several specific implementation details are included in the above discussion, these should not be construed as limiting the scope of the present disclosure. Certain features described in the context of separate embodiments may also be implemented in combination in a single embodiment. Conversely, the various features described in the context of a single embodiment may also be implemented in multiple embodiments individually or in any suitable sub-combination.

Although the present subject matter has been described using language specific to structural features and/or method logical actions, it should be understood that the subject matter as defined in the appended claims is not necessarily limited to the particular features or actions described above. Rather, the particular features and actions described above are merely example forms of claim fulfillment.

1-12. (canceled)

13. A method of displaying information, comprising:
receiving a first operation on a content block in a document; and
in response to the first operation, displaying a first function identifier in an associated area of the content block, the first function identifier comprising a first sub-identifier and a second sub-identifier, the first sub-identifier used to represent a content type of the content block, and the second sub-identifier used to represent an operation type of the content block.

14. The method of displaying information of claim 13, further comprising:
in response to a second operation by a user on the first sub-identifier, displaying a function list of the content block; and/or,
in response a third operation by a user on the second sub-identifier, moving the content block.

15. The method of displaying information of claim 13, further comprising:
if a type of the content block to which the first operation points is not determined, displaying a second function identifier.

16. The method of displaying information of claim 13, further comprising:
in response to a fourth operation by a user on a blank text line of the document, displaying a third function identifier, wherein the third function identifier is used to create the content block.

17. The method of displaying information of claim 16, further comprising:
in response to the third function identifier being selected, displaying a control panel for displaying at least one content block identifier; wherein the content block identifier and the first sub-identifier of a same content block have a correspondence.

18. The method of displaying information of claim 13, wherein,
if the content type of the content block is a non-text type, the first sub-identifier is identical to a content block identifier of the content block; and/or,
if the content type of the content block is a text type, the first sub-identifier of the content block is a text identifier.

19. The method of displaying information of claim 13, wherein if the content block is a text type comprising a title, the method further comprises:
determining the first sub-identifier based on a title level of the title.

20. The method of displaying information of claim 13, wherein if the content block is a text type, the method further comprises:
in response to receiving an operation setting a title of the content block, setting the content block to a title format; and
determining a title level of the title, and determining the first sub-identifier based on the title level of the title.

21. The method of displaying information of claim 13, wherein,
the first operation comprises a user hovering a cursor within a predetermined area corresponding to the content block.

22. The method of displaying information of claim 13, wherein the content type of the content block comprises at least one of the following:
a text type, an image type, a chart type, or a file type.

23. An electronic device, comprising:
at least one memory and at least one processor;
wherein the memory is used to store program code, and the processor is used to call the program code stored in the memory to cause the electronic device to perform acts comprising:
receiving a first operation on a content block in a document; and
in response to the first operation, displaying a first function identifier in an associated area of the content block, the first function identifier comprising a first sub-identifier and a second sub-identifier, the first sub-identifier used to represent a content type of the content block, and the second sub-identifier used to represent an operation type of the content block.

24. The device of claim 23, the acts further comprising:
in response to a second operation by a user on the first sub-identifier, displaying a function list of the content block; and/or,
in response a third operation by a user on the second sub-identifier, moving the content block.

25. The device of claim 23, the acts further comprising:
if a type of the content block to which the first operation points is not determined, displaying a second function identifier.

26. The device of claim 23, the acts further comprising:
in response to a fourth operation by a user on a blank text line of the document, displaying a third function identifier, wherein the third function identifier is used to create the content block.

27. The device of claim 26, the acts further comprising:
in response to the third function identifier being selected, displaying a control panel for displaying at least one content block identifier; wherein the content block identifier and the first sub-identifier of a same content block have a correspondence.

28. The device of claim 23, wherein,
if the content type of the content block is a non-text type, the first sub-identifier is identical to a content block identifier of the content block; and/or,
if the content type of the content block is a text type, the first sub-identifier of the content block is a text identifier.

29. The device of claim 23, wherein if the content block is a text type comprising a title, the acts further comprises:
determining the first sub-identifier based on a title level of the title.

30. The device of claim 23, wherein if the content block is a text type, the acts further comprises:
in response to receiving an operation setting a title of the content block, setting the content block to a title format; and
determining a title level of the title, and determining the first sub-identifier based on the title level of the title.

31. The device of claim 23, wherein,
the first operation comprises a user hovering a cursor within a predetermined area corresponding to the content block.

32. A non-transitory computer storage medium, wherein, the non-transitory computer storage medium stores program code that, when executed by a computer device, causes the computer device to perform acts comprising:
receiving a first operation on a content block in a document; and
in response to the first operation, displaying a first function identifier in an associated area of the content block, the first function identifier comprising a first sub-identifier and a second sub-identifier, the first sub-identifier used to represent a content type of the content block, and the second sub-identifier used to represent an operation type of the content block.
